(19) United States
(12) Patent Application Publication
(10) Pub. No.: US 2013/0176097 A1
(43) Pub. Date: Jul. 11, 2013

(54) INSULATING TRANSFORMER

(71) Applicants: Katsuo Yamada, Tokyo (JP); Kiyoshi Hironaka, Tokyo (JP); Kenichirou Suzuki, Tokyo (JP); Nobuaki Ito, Tokyo (JP)

(72) Inventors: Katsuo Yamada, Tokyo (JP); Kiyoshi Hironaka, Tokyo (JP); Kenichirou Suzuki, Tokyo (JP); Nobuaki Ito, Tokyo (JP)

(21) Appl. No.: 13/823,353

(22) PCT Filed: Jun. 17, 2011
(86) PCT No.: PCT/JP2011/003467

§ 371 Date: Mar. 14, 2013

(30) Foreign Application Priority Data
Sep. 29, 2010 (JP) 2010-218373

(51) Int. Cl. H01F 30/06

(52) U.S. Cl. CPC H01F 30/06
USPC 336/220

(57) ABSTRACT

Provided is a one-input and two-output type insulating transformer which can secure a desired insulation distance between the primary and secondary sides with a simple structure without causing an increase in the size of the product as a whole. The insulating transformer includes a first tube-shaped bobbin 1 around which a primary coil is wound, a second tube-shaped bobbin 2 in which a housing section 16 of the first bobbin 1 is formed between two winding sections 10 around each of which a secondary coil 9 is wound, and a core member 20 which forms a closed magnetic circuit by an inner core 7a inserted into hole sections 8 and 11 of the first and second bobbins 1 and 2, and by an outer core 7b arranged along the outer periphery of the second bobbin 2.

### TECHNICAL FIELD

The present invention relates to an insulating transformer which has one primary coil and two secondary coils, and which has high insulation performance between the primary and secondary coils.

### BACKGROUND ART

In recent years, a plurality of cold cathode tubes are used as light sources for screen illumination in a liquid crystal display used as a display apparatus for a personal computer, a flat-screen television, and the like. Further, an inverter transformer is used for discharging and lighting the cold cathode tubes.

The inverter transformer is configured such that an AC voltage converted from a DC input voltage in an oscillation circuit is inputted into the primary coil, and such that the inputted AC voltage is boosted to 1000 to 2000 V in the secondary coil and then the boosted voltage is outputted to the cold cathode tube.

A number of cold cathode tubes are used as light sources for screen illumination, and hence, in the case where the inverter transformers for lighting the cold cathode tubes are mounted on a circuit board, one-input and two-output type inverter transformers, each provided with two secondary coils for simultaneously or differentially lighting the two cold cathode tubes, are used in many cases in order to reduce the size of the circuit board.

Meanwhile, inverter transformers having a high-voltage specification in which the input voltage to the primary coil is in the range of several hundred volts have been widely used. Further, to meet the requirement of safety standard, it is required that the insulation between the primary and secondary coils is guaranteed by securing a longer insulation distance (creepage distance) between the primary and secondary coils as compared with transformers based on a general low-voltage specification.

On the other hand, in Patent Document 1 described below, an insulating converter transformer as a one-input and one-output type insulating transformer is proposed in which the insulation distance between the primary and secondary coils is secured in such a manner that a primary bobbin around which a primary winding is wound and on which a primary terminal is provided, and a secondary bobbin around which a secondary winding is wound and on which a secondary terminal is provided are linearly arranged in an insulating case and on both sides of a partition plate molded integrally with the insulating case.

Patent Document 1: Japanese Patent Laid-Open No. 2003-92224

### DISCLOSURE OF THE INVENTION

### Problem to be Solved by the Invention

However, when the structure described in Patent Document 1 is applied to a one-input and two-output type insulating transformer having one primary bobbin and two secondary bobbins, so as to acquire a desired insulation distance, there arises a problem that the size of the insulating case is increased, and thereby the external shape of the product as a whole also becomes bulky, so as to go against the miniaturization of the circuit board on which the insulating transformer is mounted.

The present invention has been made in view of the above-described circumstances. An object of the present invention is to provide a one-input and two-output type insulating transformer which can secure a desired insulation distance between the primary side and the secondary side by means of a simple structure without causing an increase in the size of the product as a whole.

### Means for Solving the Problem

In order to solve the above described problem, according to a first aspect of the present invention, there is provided an insulating transformer including a first tube-shaped bobbin around which a primary coil is wound, a second tube-shaped bobbin in which a housing section of the first bobbin is formed between two winding sections each provided with a secondary coil wound therearound, and a core member which forms a closed magnetic circuit by an inner core inserted into the hole sections of the first and second bobbins and by an outer core arranged along an outer periphery of the second bobbin.

Further, according to a second aspect of the present invention, in the first aspect of the present invention, the outer core is arranged on the side of one surface of the outer peripheral section of the second bobbin, and a terminal mounting section is formed, the terminal mounting section having a terminal around which the end portion of the secondary coil is wound and which projects from the side of the other surface of the outer peripheral section of the second bobbin, and in that a projecting section for positioning the outer core is formed on the one surface so that a space distance between the outer core and the terminal is set to 1 mm or more.

Further, according to a third aspect of the present invention, in one of the first and second aspects of the present invention, the core member is formed in a hollow square shape by the inner core and the outer core arranged in parallel with the inner core and along one side surface of the second bobbin, and an opening section, into which the first bobbin is inserted, is formed in another side surface of the housing section, which side surface is located on the side opposite to the one side surface, and in that the first bobbin is housed in the housing section so that a terminal mounting section, in which a terminal with the end portion of the primary coil wound therearound is provided, is made to project from the opening section.

### Advantages of the Invention

According to one of the first to third aspects of the present invention, the second bobbin made of a material having an insulating property is configured such that a housing section is formed between the two winding sections each provided with the secondary coil wound therearound, and such that the first bobbin with the primary coil wound therearound is housed in the housing section. Thereby, it is possible to obtain a desired insulation distance between the primary coil and the secondary coil by the partition walls defining the housing section.

Further, according to the second aspect of the present invention, the terminal mounting section is formed in the outer peripheral section of the second bobbin, and the outer core is positioned by forming the projecting section on the one surface of the terminal mounting section. Thereby, it is possible to form a space of 1 mm or more between the outer core and the terminal of the secondary coil, which terminal is made to project from the side of the other surface of the terminal mounting section. As a result, it is also possible to surely secure an insulation distance between the secondary coil and the core member.

In addition, according to the third aspect of the present invention, the outer core is arranged along the one side surface of the second bobbin, and the opening section of the housing section of the first bobbin is formed in the other side surface opposite to the outer core, and further the terminal mounting section, in which the terminal of the primary coil is provided, is made to project from the opening section. Thereby, it is also possible to secure a sufficient insulation distance between the primary coil and the core member.

As described above, in the insulating transformer according to the present invention, it is possible to secure a desired insulation distance between the primary side and the secondary side with a simple structure without causing an increase in the size of the product as a whole.

### BRIEF DESCRIPTION OF THE DRAWINGS

FIG. 1 is an exploded perspective view showing an embodiment of an insulating transformer according to the present invention;

FIG. 2A is a front view showing the shape of the first bobbin of FIG. 1;

FIG. 2B is a bottom view showing the shape of the first bobbin of FIG. 1;

FIG. 2C is a side view showing the shape of the first bobbin of FIG. 1;

FIG. 3A is a plan view showing the shape of the second bobbin of FIG. 1;

FIG. 3B is a front view showing the shape of the second bobbin of FIG. 1;

FIG. 3C is a side view showing the shape of the second bobbin of FIG. 1;

FIG. 4 is a sectional view taken along line X-X in FIG. 3;

FIG. 5A is a plan view showing the whole shape of the insulating transformer of the present invention;

FIG. 5B is a view taken along line Y-Y in FIG. 5A; and

FIG. 6 is a side view of FIG. 5A.

### BEST MODE FOR CARRYING OUT THE INVENTION

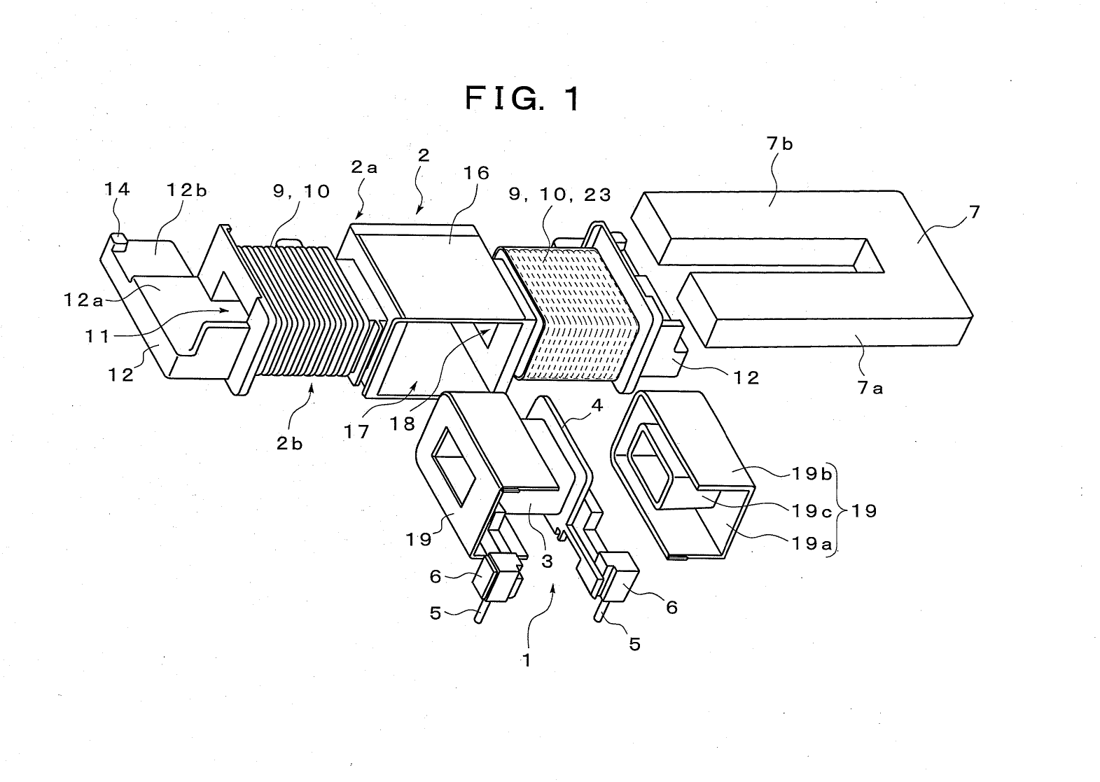

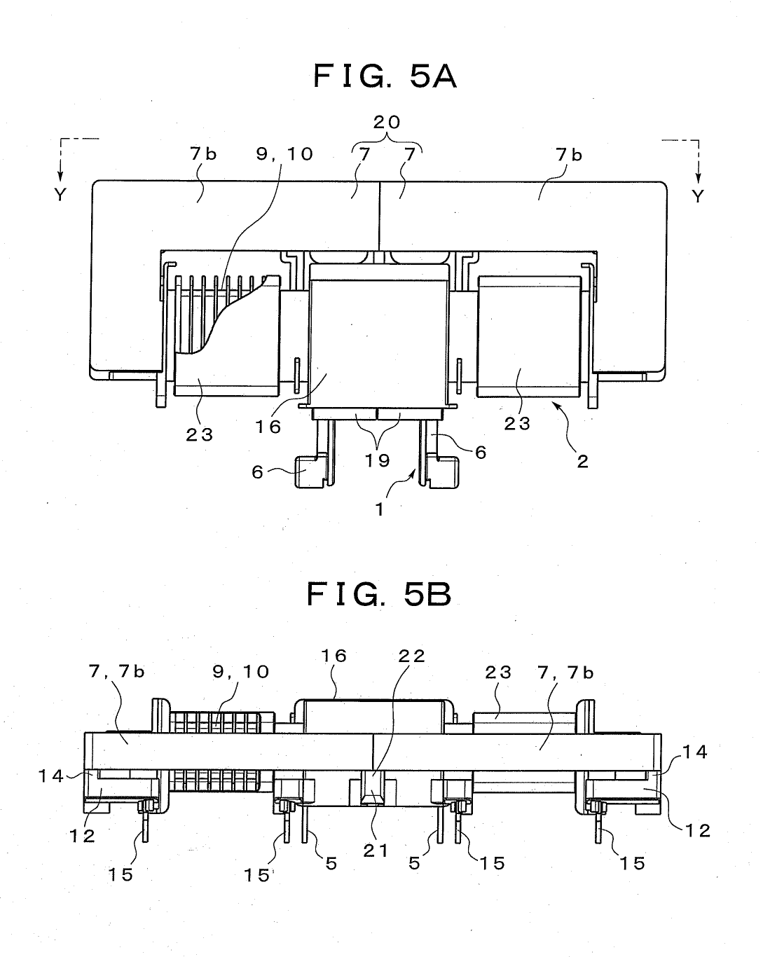

FIG. 1 to FIG. 6 show an embodiment in which an insulating transformer according to the present invention is applied to an inverter transformer. The inverter transformer is divided into a first bobbin 1 around which a primary coil is wound, and a second bobbin 2 around which two secondary coils are wound.

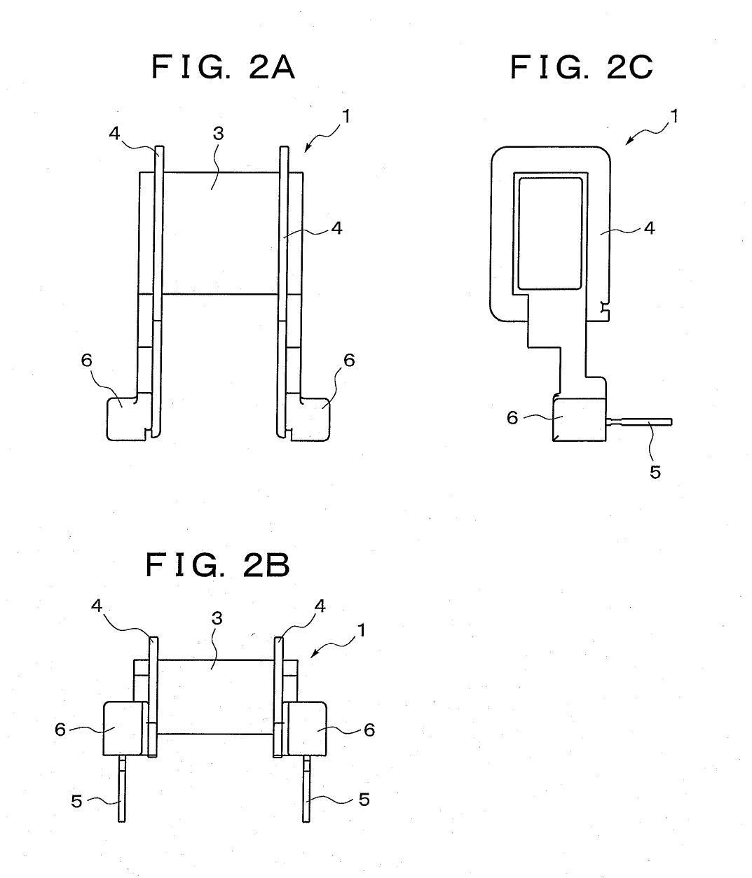

As shown in FIG. 2A to FIG. 2C, the first bobbin 1 is configured such that a primary coil (not shown) is wound around the outer periphery of a square tube-shaped winding section 3 made of synthetic resin having an electrical insulating property, and such that flange sections 4 are formed on both axial direction end sides of the winding section 3.

Further, a terminal mounting section 6, provided with a terminal 5 which extends in the direction perpendicular to the axial line of the winding section 3, and the distal end of which is connected to the end portion of the primary coil, is integrally formed on the outer surface side of each of the flange sections 4. Further, a hole section 8, into which an inner core 7a of a U-shaped core 7 described below is inserted, is formed at the center portion of the first bobbin 1.

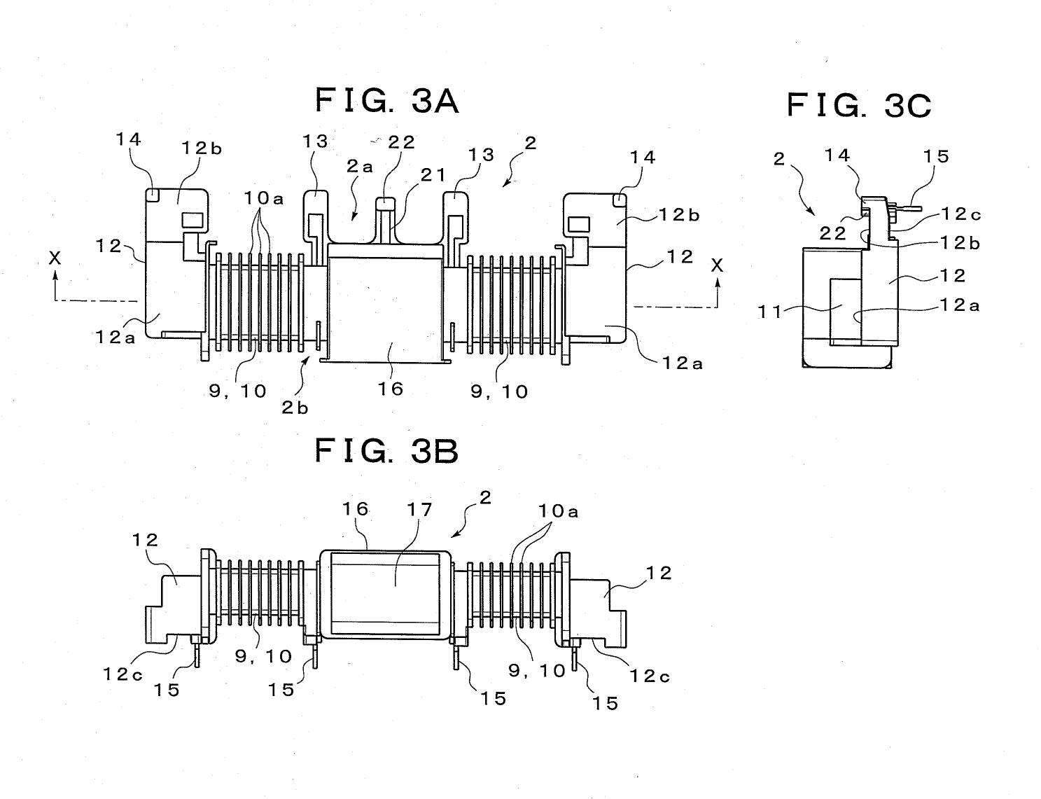

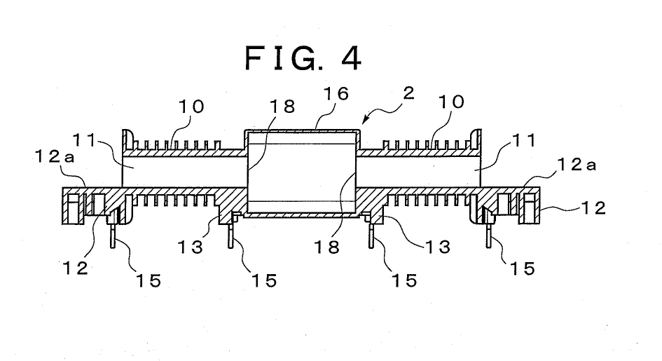

On the other hand, as shown in FIG. 3A to FIG. 3C, and FIG. 4, the second bobbin 2 is similarly a member which has a substantially square tube-shape as a whole and which is made of synthetic resin having an electrical insulating property. On each of both axial direction end sides of the second bobbin 2, a winding section 10, around which a secondary coil 9 is wound, is formed. Note that a plurality of partition plates 10a for preventing creeping discharge in the high-voltage secondary coil 9 are integrally formed at regular intervals in the axial direction on the outer periphery of each of the winding sections 10. Further, a hole section 11, in which the inner core 7a of the U-shaped core 7 is inserted, is formed at the center portion of the second bobbin 2.

Further, at both end portions of each of the winding sections 10, terminal mounting sections 12 and 13 projected to the side of one side surface 2a of the second bobbin 2 are formed in the direction perpendicular to the axial line of the winding sections 10. Here, the terminal mounting section 12 located at each of both end portions of the second bobbin 2 is formed so that the surface 12a of the terminal mounting section 12 is on the same plane with the inner wall surface of the hole section 11 so as to open the hole section 11 of the winding section 10.

Further, a projecting section 14 is integrally formed at the distal end of one surface 12b of each of the terminal mounting sections 12, which one surface 12b faces the side of the hole section 11, and a terminal 15, around which the end portion of the secondary coil 9 is wound, is projectingly provided on the surface 12c formed on the back surface side of the surface 12b. Further, the terminal 15, around which the end portion of the secondary coil 9 is wound, is similarly projectingly provided at the terminal mounting section 13. Further, a supporting section 21, on which the outer core 7b of the U-shaped core 7 is mounted, is formed between both the terminal mounting sections 13, and a projecting section 22, the upper surface of which is on the same plane with the projecting section 14 of the terminal mounting section 12, is formed at the distal end of the supporting section 21.

Further, in the second bobbin 2, a housing section 16 of the first bobbin 1 is formed in the central portion located between the two winding sections 10.

The housing section 16 is a box-like space with an opening section 17 formed in the side surface 2b on the side opposite to the one side surface 2a on which the terminal mounting sections 12 and 13 are projectingly provided. In the inner wall of the housing section 16, an opening section 18 communicating with the hole section 11 of the winding section 10 is bored.

In this configuration, the first bobbin 1 is inserted into the housing section 16. Here, as shown in FIG. 1, the first bobbin 1 is provided in the housing section 16 in the state where all the surfaces of the outer peripheral surface of the primary coil, the outer surface of the flange section 4, and the inner peripheral surface of the hole section 8 are covered with an insulating cover 19 divided into two parts. That is, the insulating cover 19 is formed by a flat plate section 19a covering the end surface of flange section 4 of the first bobbin 1, an outer covering section 19b covering the outer periphery of the primary coil, and an inner covering section 19c covering the inner peripheral surface of the hole section 8 of the first bobbin 1, and the terminal mounting section 6 is arranged at the opening section of the outer covering section 19b.

Note that the flat plate section 19a and the outer covering section 19b are formed to have a size such that, when the first bobbin 1 is housed in the housing section 16, a part of each of the flat plate section 19a and the outer covering section 19b is made to project from the housing section 16. Further, the first bobbin 1 is housed in the housing section 16 so as to allow a part of each of the flat plate section 19a and the outer covering section 19b, and the terminal mounting section 6 to project from the opening section 17.

A core member 20 forming a closed magnetic circuit is arranged around the first bobbin 1 and the second bobbin 2 configured as described above. Here, the core member 20 is formed in a hollow square shape as a whole by a pair of the U-shaped cores 7, and one of the side sections of each of the U-shaped cores 7 is inserted, as the inner core 7a, from the hole section 11 of the second bobbin 2 into the inner covering section 19c of the insulating cover 19 covering the hole section 8 of the first bobbin 1 in the housing section 16.

Further, the other side section of the U-shaped core 7 is arranged, as the outer core 7b, on the surface 12a of the terminal mounting section 12 of the second bobbin 2 and along the one side surface 2a of the second bobbin 2, so as to be mounted on the projecting section 14 of the terminal mounting section 12, and on the projecting section 22 of the supporting section 21.

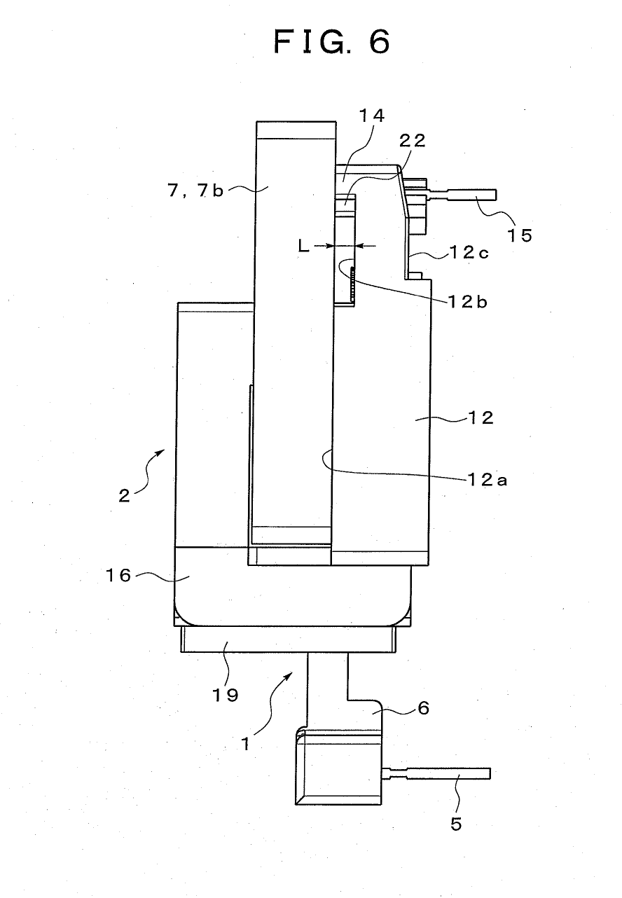

Here, as shown in FIG. 6, the height dimension of the projecting sections 14 and 22 is set so that a space distance L between the lower surface of the outer core 7b and the terminal 15 becomes 1 mm or more.

Further, the pair of U-shaped cores 7 are arranged in an opposed confronting relation so that the end surfaces of the pair of inner cores 7a are in contact with each other and so that the end surfaces of the pair of outer cores 7b are in contact with each other.

Further, an insulating tape 23 is wound around the outer periphery of the secondary coil 9.

In the inverter transformer configured as described above, the housing section 16 is formed between the two winding sections 10 of the second bobbin 2, around each of which the secondary coil 9 is wound, and further the first bobbin 1, around which the primary coil is wound, is housed in the housing section 16. Therefore, a desired insulation distance can be obtained between the primary coil and the secondary coil 9 by the partition walls defining the housing section 16.

Further, the outer core 7b is positioned in such a manner that the terminal mounting sections 12 and 13 are formed in the outer peripheral section of the second bobbin 2, and that the projecting section 14 is formed on the one surface 12b of the terminal mounting section 12. Thus, the space distance L of 1 mm or more, which is specified as a gap based on the safety standard, can be formed between the outer core 7b and the terminals 15 of the secondary coil which project from the side of the other surfaces 12c of the terminal mounting sections 12 and 13. As a result, the insulation distance can be surely secured also between the secondary coil and the core members.

In addition, the outer core 7b is arranged along the one side surface 2a of the second bobbin 2, and the opening section 17 of the housing section 16 of the first bobbin 1 is formed in another side surface 2b on the side opposite to the outer core 7b. Also, the terminal mounting section 6, in which the terminal 5 of the primary coil in the first bobbin 1 is provided, is made to project from the opening section 17. Consequently, it is possible to secure a long insulation distance between the outer core 7b and the terminal 5 of the primary coil.

Further, the end surface of the flange section 4 of the first bobbin 1, the outer peripheral surface of the primary coil, and the inner peripheral surface of the hole section 8 are covered with the insulating cover 19, and also a part of the insulating cover 19 is made to project from the opening section 17. Thus, it is also possible to secure a sufficient insulation distance between the primary coil wound around the first bobbin 1, and the inner core 7a inserted into the hole sections 8 and 11.

Note that, in the above-described embodiment, only the case where the core member 20 forming the hollow square-shaped closed magnetic circuit is constituted by the pair of U-shaped cores 7 is described, but the present invention is not limited to this. For example, the core member 20 can also be configured by magnetically connecting both end portions of an I-shaped inner core inserted into the hole sections 8 and 11, with both end portions of a C-shaped outer core arranged on the outer periphery of the second bobbin.

### INDUSTRIAL APPLICABILITY

The insulating transformer according to the present invention can be used as a one-input and two-output type insulating transformer which is used as an inverter transformer, and the like, for lighting cold cathode tubes of a liquid crystal display used as a display apparatus for a flat-screen television and the like.

### DESCRIPTION OF SYMBOLS

1 First bobbin
2 Second bobbin
2a One side surface
2b Opposite side surface
3, 10 Winding section
5, 15 Terminal
6, 12, 13 Terminal mounting section
7 U-shaped core
7a Inner core
7b Outer core
8, 11 Hole section
9 Secondary coil
12b One surface
12c The other surface
14, 22 Projecting section
16 Housing section
17 Opening section
20 Core member

1. An insulating transformer comprising: a first tube-shaped bobbin around which a primary coil is wound; a second tube-shaped bobbin in which a housing section of the first bobbin is formed between two winding sections around each of which a secondary coil is wound; and a core member which forms a closed magnetic circuit by an inner core inserted into hole sections of the first and second bobbins and by an outer core arranged along an outer periphery of the second bobbin.

2. The insulating transformer according to claim 1, wherein the outer core is arranged on the side of one surface of the outer peripheral section of the second bobbin, and a terminal mounting section is formed, the terminal mounting section having a terminal around which the end portion of the secondary coil is wound and which projects from the side of the other surface of the outer peripheral section of the second bobbin, and a projecting section for positioning the outer core is formed on the one surface so that a space distance between the outer core and the terminal is set to 1 mm or more.

3. The insulating transformer according to claim 1, wherein the core member is formed in a hollow square shape by the inner core and the outer core arranged in parallel with the inner core and along one side surface of the second bobbin, and an opening section, into which the first bobbin is inserted, is formed in another side surface of the housing section, which side surface is located on the side opposite to the one side surface, and the first bobbin is housed in the housing section so that a terminal mounting section, in which a terminal with the end portion of the primary coil wound therearound is provided, is made to project from the opening section.
